(19) United States
(12) Patent Application Publication
(10) Pub. No.: US 2026/0294593 A1
(43) Pub. Date: Oct. 1, 2026

(54) IMPROVED PROSTHESIS FITTING

(71) Applicant: Fu-Yi LIN, Taipei (TW)

(72) Inventor: Fu-Yi LIN, Taipei (TW)

(21) Appl. No.: 18/998,146

(22) PCT Filed: Aug. 1, 2022
(86) PCT No.: PCT/CN2022/109472

§ 371 Date: Jan. 24, 2025

(51) Int. Cl. A61C 8/00

(52) U.S. Cl. CPC A61C 8/008; A61C 8/0069; A61C 8/0096

(57) ABSTRACT

Provided is an improved prosthesis fitting comprising a nut, a healing cap, and an abutment. The structure or the nut, the healing cap, and the abutment is at least one convex ring structure selected from a first convex ring and a second convex ring. The placement method of the present invention is to specifically use the structure of the first convex ring and the second convex ring to assist in stable growth of gums and tooth bone, thereby avoiding the situation in the prior art that gums and tooth bone that have not completely healed cannot easily grow and heal when being compressed.

### FIELD OF THE INVENTION

An accessory for dental implants, specifically an improved prosthetic component.

### THE PRIOR ARTS

In existing technology, dental implant involves directly placing an abutment on the implant at the required position. However, the gum tissue and surrounding bone are not yet fully healed to cover and stabilize the abutment. Consequently, a prosthetic crown is placed on the abutment in a unstable state where the surrounding gum tissue and bone are not yet robust. This structural approach in existing technology does not provide a strong foundation for the prosthetic crown placed on the abutment.

### SUMMARY OF THE INVENTION

### Technical Problem

This invention aims to provide an improved prosthetic component to address the issue in current dental implant treatments where the incomplete healing of gum tissue and bone makes it difficult to achieve proliferation and healing when subjected to compression.

### Technical Solution

The invention provides an improved prosthetic component, comprising:
A cover screw with an upper body and a lower threaded section. The threaded section is secured to a dental implant situated in the alveolar bone.
The esthetic cover screw includes a protruding ring structure, selected from at least one of a first ring and a second ring. The second ring is located at the top extension of the cap body, while the first ring is located at the upper extension of the second ring.

When the screw cap features only the first ring's annular structure, the space between the first ring and the threaded section accommodates either the gum tissue or bone.

When the screw cap features both the first and second ring structures, the space between these rings and the cap body accommodates either proliferating gum tissue or bone.

When the screw cap features only the second ring's annular structure, the space between the second ring and the threaded section accommodates either proliferating gum tissue or bone.

The gum tissue forms part of the gingiva, and the bone forms part of the alveolar bone.

The invention also provides an improved healing cap, comprising:
A healing cap with an upper crown section, a conical section extending downward from the crown section, and a cap body joined to the bottom of the conical section. The cap body is joined to a threaded section secured to a dental implant located in the alveolar bone.

The healing cap includes a protruding ring structure, selected from at least one of a first ring and a second ring.
The first ring is located at the junction between the cap body and the conical section.
The second ring is located at the junction between the crown section and the conical section.

When the healing cap features only the first ring's annular structure, the space between the first ring and the threaded section accommodates either proliferating gum tissue or bone.

When the healing cap features only the second ring's annular structure, the space between the second ring and the threaded section accommodates either proliferating gum tissue or bone.

When the healing cap features both the first and second ring structures, the space between these rings accommodates either proliferating gum tissue or bone.

The gum tissue forms part of the gingiva, and the bone forms part of the alveolar bone.

The invention also introduces an improved prosthetic component, comprising:
A healing cap with an upper crown section, a conical section extending downward from the crown section, a cap body joined to the bottom of the conical section, and a threaded section joined to the bottom of the cap body. The threaded section is secured to a dental implant in the alveolar bone.

The healing cap includes a protruding ring structure, selected from at least one of a first ring and a second ring.
The first ring is located at the junction between the top of the conical section and the crown section.
The second ring is located at the junction between the bottom of the crown section and the conical section.

When the healing cap features only the first ring's annular structure, the space between the first ring and the threaded section accommodates either proliferating gum tissue or bone.

When the first ring is located between the crown section and the conical section, it includes a first recessed groove. The space within the first recessed groove accommodates either proliferating gum tissue or bone.

When the second ring is located between the conical section and the crown section, it includes a second recessed groove. The space within the second recessed groove accommodates either proliferating gum tissue or bone.

The space between the annular structure formed by the protrusions of the healing cap and the threaded portion of the healing cap accommodates at least one of the proliferating gum tissue or bone. The gum tissue forms part of the gingiva, and the bone forms part of the alveolar bone.

This invention provides an improved prosthetic component, including: an abutment tooth, which is selected from at least one structure between a one-piece integrated structure and a two-piece combined structure. For the one-piece integrated structure, the abutment tooth includes: an upper support crown, the lower end of the support crown connects to a conical section, the lower end of the conical section connects to a cap body, and the lower end of the cap body connects to a threaded portion. The threaded portion is secured to a dental implant, which is located within the alveolar bone.

The protruding ring structure of the abutment tooth is selected from at least one of a first ring and a second ring. The first ring of the abutment tooth is located at the junction between the support crown and the conical section, while the second ring is located at the junction between the conical section and the cap body.

When only the annular structure of the first ring of the abutment tooth is present, the space between the first ring and the cap body accommodates at least one of the proliferating gum tissue or bone. When the annular structure of both the first and second rings of the abutment tooth is present, the space between the first and second rings and the conical section accommodates at least one of the proliferating gum tissue or bone. When only the annular structure of the second ring of the abutment tooth is present, the space between the second ring and the cap body accommodates at least one of the proliferating gum tissue or bone. The gum tissue forms part of the gingiva, and the bone forms part of the alveolar bone.

For the two-piece combined structure of the abutment tooth, it includes: the upper end of the abutment having the support crown, the lower end of the support crown connects to the conical section, and the lower end of the conical section connects to the cap body. The abutment tooth has a movable screw, and the central cavity of the support crown, conical section, and cap body of the abutment tooth shares a common axis, forming a perforation. The movable screw is set in the central cavity of the perforation passing through the support crown, conical section, and cap body of the abutment tooth. One end of the movable screw is threaded, and it passes through the perforation to lock the abutment tooth onto the dental implant, which is located within the alveolar bone.

The protruding ring structure of the abutment tooth is selected from at least one of a first ring and a second ring. The first ring of the abutment tooth is located at the junction between the support crown and the conical section, while the second ring is located at the junction between the conical section and the cap body.

When only the annular structure of the first ring of the abutment tooth is present, the space between the first ring and the cap body accommodates at least one of the proliferating gum tissue or bone. When both the annular structures of the first and second rings of the abutment tooth are present, the space between the first and second rings and the conical section accommodates at least one of the proliferating gum tissue or bone. When only the annular structure of the second ring of the abutment tooth is present, the space between the second ring and the cap body accommodates at least one of the proliferating gum tissue or bone. The gum tissue forms part of the gingiva, and the bone forms part of the alveolar bone.

### Advantages of the Invention

The advantages of this invention include:

This invention provides an improved prosthetic component that specifically uses the structures of the first and second rings to aid in the stable proliferation of gum tissue and bone. It prevents the difficulty in proliferation and healing caused by compression on incompletely healed gum tissue and bone in existing technology. Additionally, this invention shortens the healing period for dental implants and enhances the effectiveness and purpose of proliferation and healing.

### BRIEF DESCRIPTION OF THE DRAWINGS

FIG. 1A is a schematic diagram of the nut of the improved prosthetic accessory of this invention before installation;

FIG. 1B is a schematic diagram of the nut of the improved prosthetic accessory of this invention after installation;

FIG. 1C is a schematic diagram of the nut structure with a first convex ring in the improved prosthetic accessory of this invention;

FIG. 1D is a schematic diagram of the nut structure with a second convex ring in the improved prosthetic accessory of this invention;

FIG. 1E is a schematic diagram of the nut structure with a first convex ring and a second convex ring in the improved prosthetic accessory of this invention;

FIG. 2A is a schematic diagram of the healing cap of the improved prosthetic accessory of this invention before placement;

FIG. 2B is a schematic diagram of the healing cap of the improved prosthetic accessory of this invention after placement;

FIG. 2C is a schematic diagram of the healing of the gums after the healing cap of the improved prosthetic accessory of this invention is placed;

FIG. 2D is a schematic diagram of the healing cap structure with a first convex ring and a first concave groove in the improved prosthetic accessory of this invention;

FIG. 2E is a schematic diagram of the healing cap structure with a first convex ring in the improved prosthetic accessory of this invention;

FIG. 2F is a schematic diagram of the healing cap structure with a second convex ring and a first concave groove in the improved prosthetic accessory of this invention;

FIG. 2G: Schematic diagram of the healing cap structure with the first convex ring and second convex ring in the improved prosthetic accessory of this invention;

FIG. 2H: Schematic diagram of the healing cap structure with the second convex ring in the improved prosthetic accessory of this invention;

FIG. 2I: Schematic diagram of the healing cap structure with the first convex ring in the improved prosthetic accessory of this invention;

FIG. 3A: Schematic diagram of the abutment tooth placement before in the improved prosthetic accessory of this invention;

FIG. 3B: Schematic diagram of the abutment tooth placement after in the improved prosthetic accessory of this invention;

FIG. 3C: Schematic diagram of the abutment tooth being covered with a denture cap in the improved prosthetic accessory of this invention;

FIG. 3D: Schematic diagram of the abutment tooth structure with the first convex ring in the integrally formed structure of the improved prosthetic accessory of this invention;

FIG. 3E: Schematic diagram of the abutment tooth structure with the first convex ring and second convex ring in the integrally formed structure of the improved prosthetic accessory of this invention;

FIG. 3F: Schematic diagram of the abutment tooth structure with the second convex ring in the integrally formed structure of the improved prosthetic accessory of this invention;

FIG. 3G: Schematic diagram of the two-part combination structure with the movable screw not locked into the abutment tooth structure in the improved prosthetic accessory of this invention;

FIG. 3H: Schematic diagram of the two-part combination structure with the movable screw locked into the abutment tooth structure in the improved prosthetic accessory of this invention;

FIG. 3I: Schematic diagram of the two-part combination structure with the movable screw not locked into the abutment tooth structure with the first convex ring in the improved prosthetic accessory of this invention;

FIG. 3J: Schematic diagram of the two-part combination structure with the movable screw not locked into the abutment tooth structure with the first convex ring and second convex ring in the improved prosthetic accessory of this invention;

FIG. 3K: Schematic diagram of the two-part combination structure with the movable screw not locked into the abutment tooth structure with the second convex ring in the improved prosthetic accessory of this invention;

### DIAGRAM LABELING EXPLANATION

dental implant 1; crown 11; root 12; alveolar bone 13; gingiva 16; screw cap 2; first ring 21; cap body 22; threaded portion 23; second ring 24; healing cap 3; first recessed groove 301; second recessed groove 302; crown portion 31; first ring 311; second ring 312; conical portion 32; cap body portion 33; threaded portion 34; abutment tooth 4; movable screw 40; perforation 401; support crown 41; first ring 411; conical portion 42; second ring 421; cap body portion 43; threaded portion 44; fastener 61. Wherein dental implant 1 is also defined implant body 1; screw cap 2 is also defined nut 2; first protruding ring 21 is also defined first convex ring 21; cap body 22 is also defined body part 22; second protruding ring 24 is also defined second convex ring 24; crown portion 31 is also defined cap crown part 31; first ring 311 is also defined first convex ring 311; second ring 312 is also defined second convex ring 312; first protruding ring 411 is also defined first convex ring 411; conical portion 42 is also defined cap taper part 42; second protruding ring 421 is also defined second convex ring 421; cap body portion 43 is also defined cap body part 43; threaded portion 44 is also defined threaded part 44; fastener 61 is also defined locker 61.

### DETAILDESCRIPTION

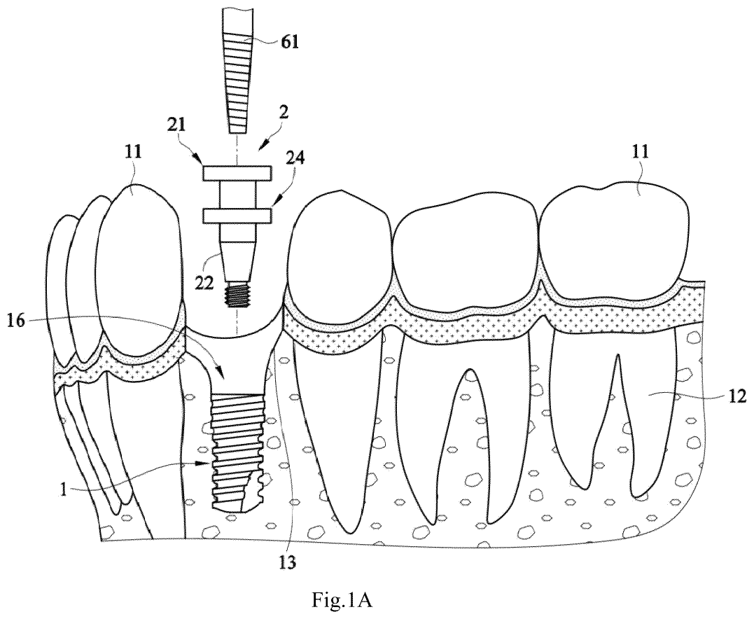

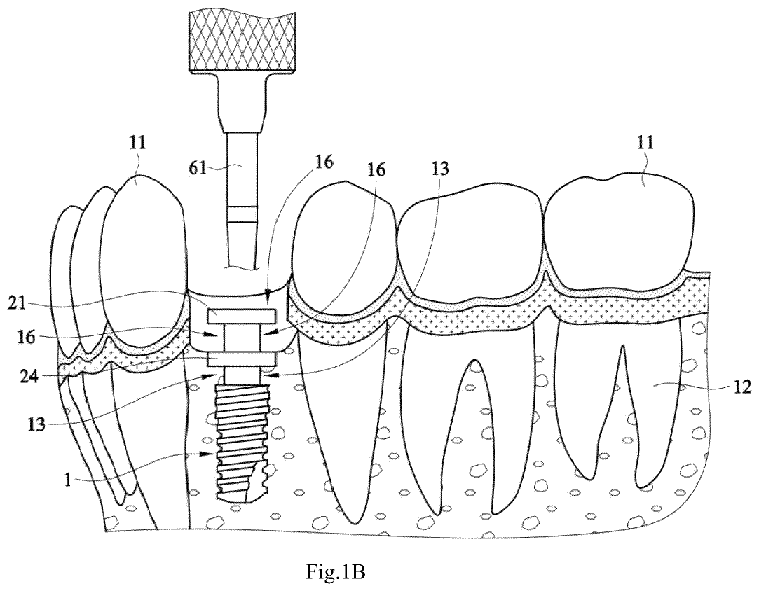

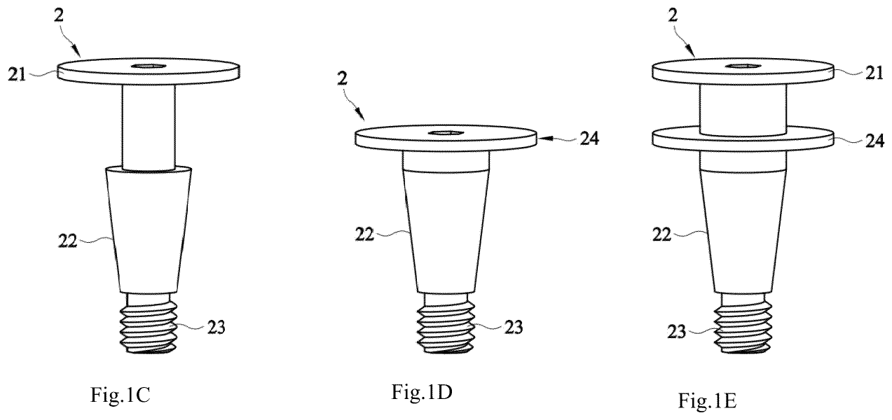

As shown in FIGS. 1A to 1E, an embodiment of the improved prosthetic component of this invention includes: a screw cap 2, where the upper end of the screw cap 2 has a cap body portion 22, and the lower end of the screw cap 2 has a threaded portion 23, the cap body portion 22 connects to the threaded portion 23, where the threaded portion 23 locks into a dental implant 1, and the dental implant 1 is located in an alveolar bone 13; where the screw cap 2 has a protruding ring structure, selected from at least one of a first protruding ring 21 and a second protruding ring 24; where the second protruding ring 24 of the screw cap 2 is located at the top extension of the cap body portion 22, and the first protruding ring 21 is located at the upper extension of the second protruding ring 24 of the screw cap 2; where it only has the first protruding ring 21 of the screw cap 2 with an annular structure, and the space between the first protruding ring 21 of the screw cap 2 and the threaded portion 23 is to accommodate proliferating gum tissue or bone, at least one of them;

The annular structure formed by the protrusion of the first ring 21 of the screw cap 2, the annular structure formed by the protrusion of the second ring 24 of the screw cap 2, and the space between these annular structures and the cap body 22 of the screw cap 2 accommodate at least one of the proliferating gum tissue or bone. When only the annular structure formed by the protrusion of the second ring 24 of the screw cap 2 exists, the space between the second ring 24 and the threaded portion 23 accommodates at least one of the proliferating gum tissue or bone. The gum tissue forms part of the gingiva 16, and the bone forms part of the alveolar bone 13. The respective positions of the crown 11, root 12, alveolar bone 13, and gingiva 16 are shown in FIGS. 1A, 2A, and 3A. The respective positions where the fastener 61 secures the screw cap 2, healing cap 3, and abutment tooth 4 are shown in FIGS. 1A, 1B, 2B, and 3B.

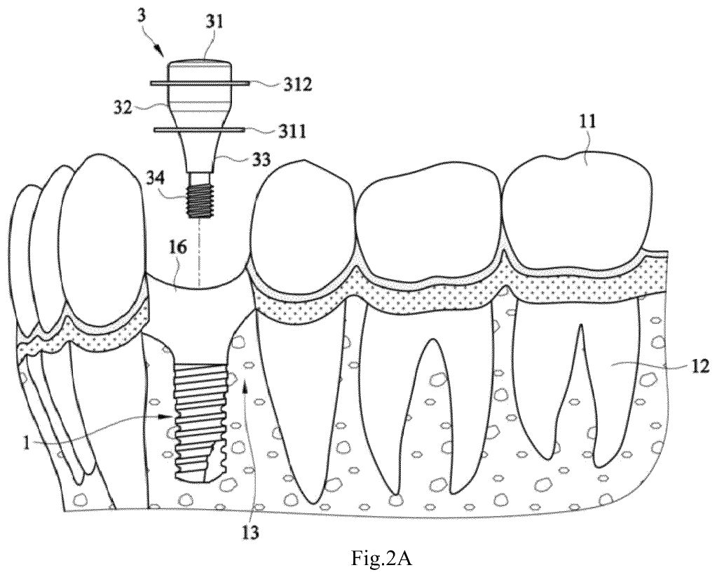

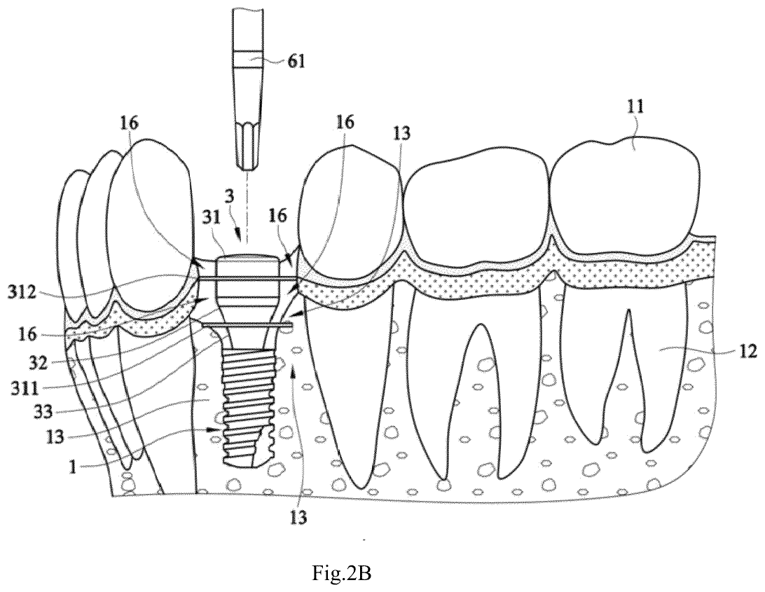

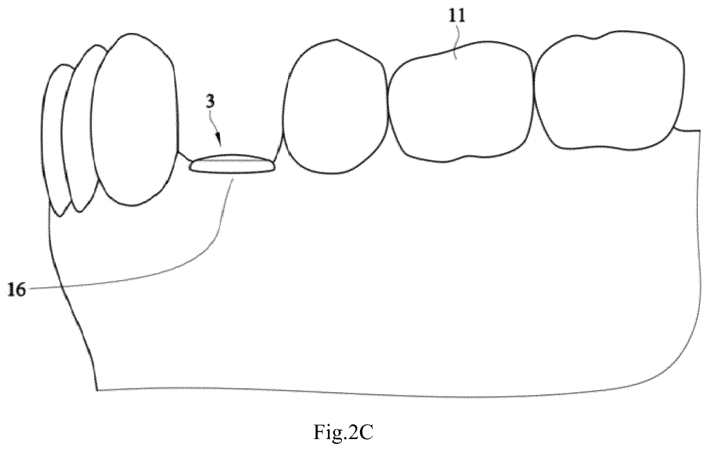

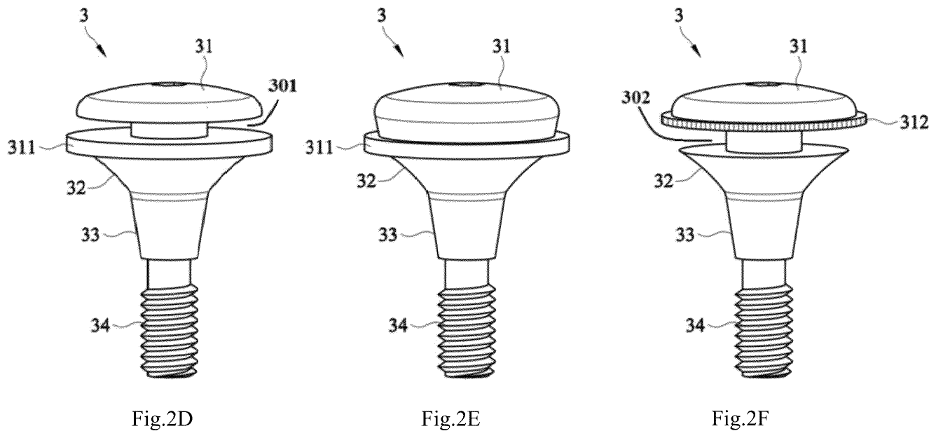

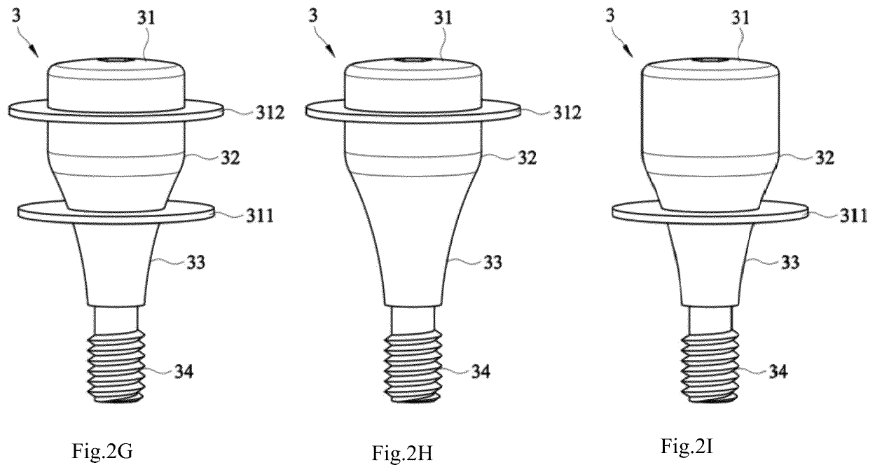

As shown in FIGS. 2A to 2C and FIGS. 2G to 21, an embodiment of the improved prosthetic component of this invention includes: a healing cap 3. The upper end of the healing cap 3 has a crown portion 31. The lower end of the crown portion 31 extends into a conical portion 32, and the lower end of the conical portion 32 connects to a cap body portion 33. The lower end of the cap body portion 33 connects to a threaded portion 34. The threaded portion 34 is secured to a dental implant 1, which is located in an alveolar bone 13.

The protruding ring structure of the healing cap 3 is selected from at least one of the first ring 311 and the second ring 312. The first ring 311 of the healing cap 3 is located at the junction between the cap body portion 33 and the conical portion 32. The second ring 312 of the healing cap 3 is located at the junction between the crown portion 31 and the conical portion 32.

When only the annular structure formed by the protrusion of the first ring 311 of the healing cap 3 exists, the space between the first ring 311 and the threaded portion 34 accommodates at least one of the proliferating gum tissue or bone. When only the annular structure formed by the protrusion of the second ring 312 of the healing cap 3 exists, the space between the second ring 312 and the threaded portion 34 accommodates at least one of the proliferating gum tissue or bone. When both the first ring 311 and the second ring 312 of the healing cap 3 exist, the space between the first ring 311 and the second ring 312 accommodates at least one of the proliferating gum tissue or bone.

The space between the annular structure formed by the protrusion of the second ring 312 and the threaded portion 34 of the healing cap 3 accommodates at least one of the proliferating gum tissue or bone. The gum tissue forms part of the gingiva 16, and the bone forms part of the alveolar bone 13.

As shown in FIGS. 2D to 2F, an embodiment of the improved prosthetic component of this invention includes: a healing cap 3. The upper end of the healing cap 3 has a crown portion 31. The lower end of the crown portion 31 extends into a conical portion 32, and the lower end of the conical portion 32 connects to a cap body portion 33. The lower end of the cap body portion 33 connects to a threaded portion 34. The threaded portion 34 is secured to a dental implant 1, which is located in an alveolar bone 13.

The protruding ring structure of the healing cap 3 is selected from at least one of the first ring 311 and the second ring 312. The first ring 311 of the healing cap 3 is located at the junction between the cap body portion 33 and the conical portion 32. The second ring 312 of the healing cap 3 is located at the junction between the crown portion 31 and the conical portion 32.

When only the annular structure formed by the first ring 311 of the healing cap 3 exists, the space between the first ring 311 and the threaded portion 34 accommodates at least one of the proliferating gum tissue or bone. Between the annular structure formed by the first ring 311 of the healing cap 3 and the crown portion 31, there is also: a first recessed groove 301, the space of which accommodates at least one of the proliferating gum tissue or bone. Between the annular structure formed by the second ring 312 of the healing cap 3 and the conical portion 32, there is a second recessed groove 302, the space of which accommodates at least one of the proliferating gum tissue or bone.

The space between the annular structure formed by the second ring 312 of the healing cap 3 and the threaded portion 34 accommodates at least one of the proliferating gum tissue or bone. The gum tissue forms part of the gingiva 16, and the bone forms part of the alveolar bone 13.

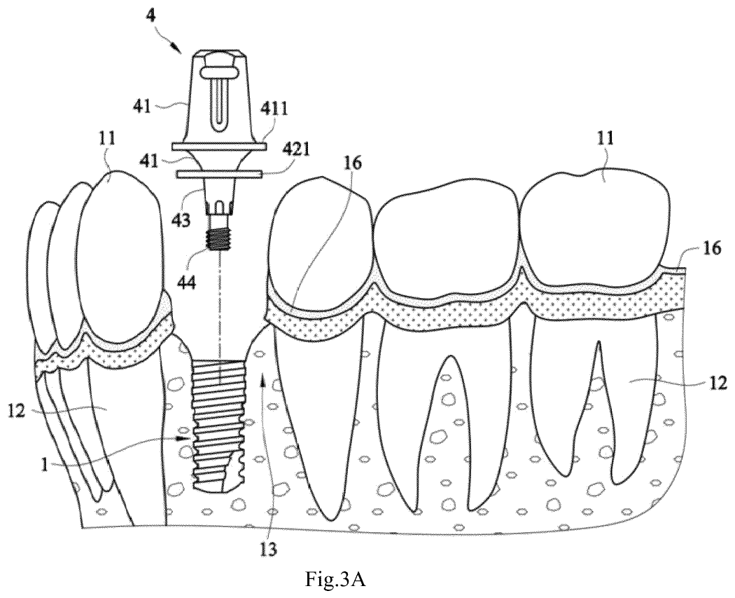

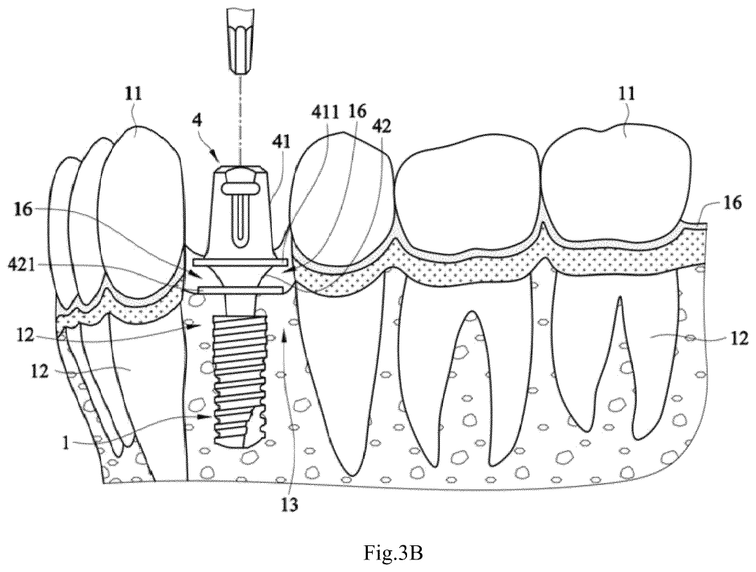

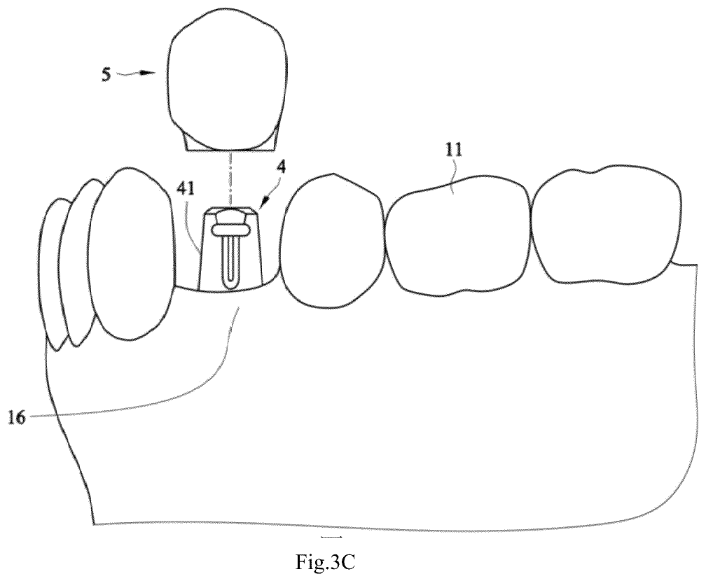

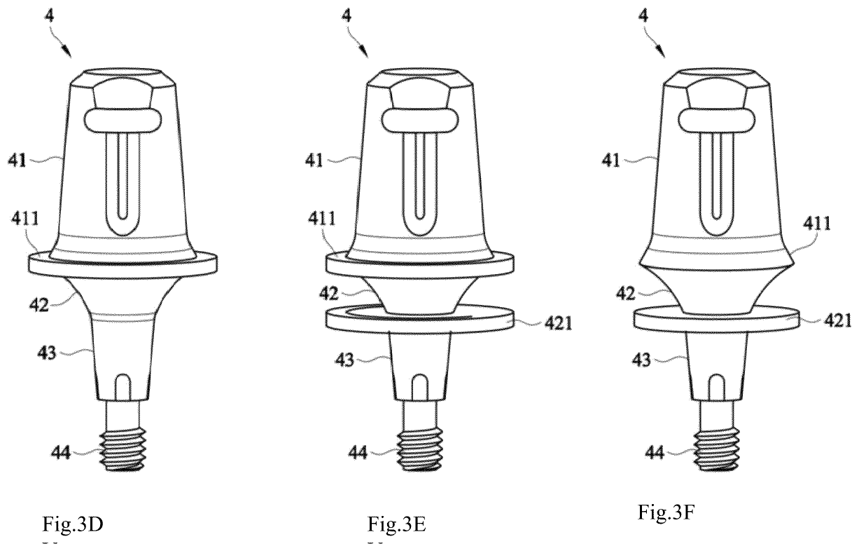

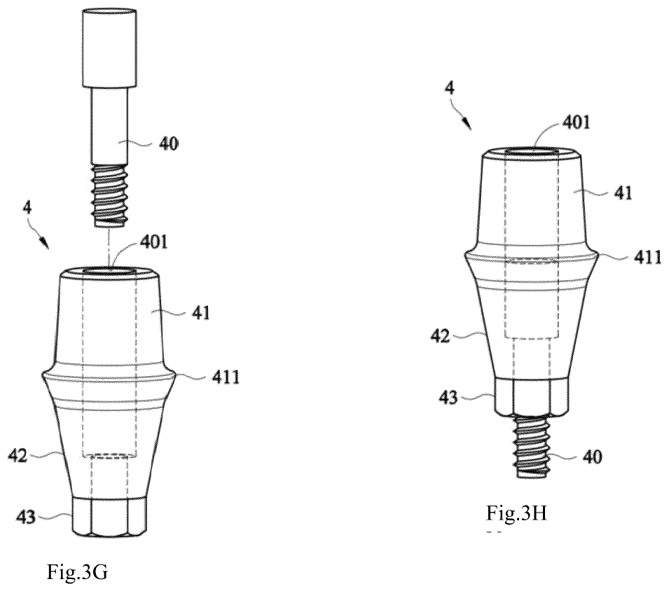

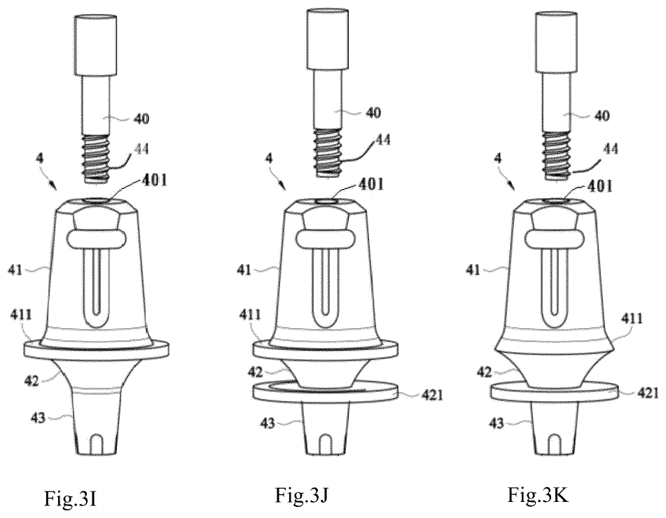

As shown in FIGS. 3A to 3F, an embodiment of the improved prosthetic component of the present invention includes: an abutment tooth 4, which is selected from at least one structure of a one-piece integrated structure and a two-piece combined structure. For the one-piece integrated structure, the abutment tooth 4 includes: the upper end of the abutment tooth 4 having a support crown 41, the lower end of the support crown 41 connecting to a conical portion 42, the lower end of the conical portion 42 connecting to a cap body portion 43, and the lower end of the cap body portion 43 connecting to a threaded portion 44. The threaded portion 44 is secured to a dental implant 1, which is located in an alveolar bone 13.

The protruding ring structure of the abutment tooth 4 is selected from at least one of a first ring 411 and a second ring 421. The first ring 411 of the abutment tooth 4 is located at the junction between the support crown 41 and the conical portion 42, and the second ring 421 is located at the junction between the conical portion 42 and the cap body portion 43.

When only the annular structure formed by the protrusion of the first ring 411 of the abutment tooth 4 exists, the space between the first ring 411 and the cap body portion 43 accommodates at least one of the proliferating gum tissue or bone. When both the annular structures formed by the first ring 411 and the second ring 421 of the abutment tooth 4 exist, the space between these two rings and the conical portion 42 accommodates at least one of the proliferating gum tissue or bone. When only the annular structure formed by the protrusion of the second ring 421 of the abutment tooth 4 exists, the space between the second ring 421 and the cap body portion 43 accommodates at least one of the proliferating gum tissue or bone. The gum tissue forms part of the gingiva 16, and the bone forms part of the alveolar bone 13.

As shown in FIGS. 3G to 3K, an embodiment of the improved prosthetic component of the present invention includes: an abutment tooth 4, selected from at least one structure of a one-piece integrated structure and a two-piece combined structure. For the two-piece combined structure, the abutment tooth 4 includes: the upper end of the abutment tooth 4 having a support crown 41, the lower end of the support crown 41 connecting to a conical portion 42, the lower end of the conical portion 42 connecting to a cap body portion 43, and the abutment tooth 4 having a movable screw 40. The central cavity of the support crown 41, conical portion 42, and cap body portion 43 of the abutment tooth 4 has a common axis, forming a perforation 401. The movable screw 40 is placed in the central cavity of the perforation 401 passing through the support crown 41, conical portion 42, and cap body portion 43. One end of the movable screw 40 is threaded, and it passes through the perforation 401 to lock the abutment tooth 4 into the dental implant 1, which is located in the alveolar bone 13.

The protruding ring structure of the abutment tooth 4 is selected from at least one of a first ring 411 and a second ring 421. The first ring 411 of the abutment tooth 4 is located at the junction between the support crown 41 and the conical portion 42, and the second ring 421 is located at the junction between the conical portion 42 and the cap body portion 43.

When only the annular structure formed by the first ring 411 of the abutment tooth 4 exists, the space between the first ring 411 and the cap body portion 43 accommodates at least one of the proliferating gum tissue or bone. When both the annular structures formed by the first ring 411 and the second ring 421 of the abutment tooth 4 exist, the space between these two rings and the conical portion 42 accommodates at least one of the proliferating gum tissue or bone. When only the annular structure formed by the protrusion of the second ring 421 of the abutment tooth 4 exists, the space between the second ring 421 and the cap body portion 43 accommodates at least one of the proliferating gum tissue or bone. The gum tissue forms part of the gingiva 16, and the bone forms part of the alveolar bone 13.

As shown in FIGS. 1A to 1E, and FIGS. 2A to 2F, the method of placing an improved prosthetic component of the present invention, which uses a screw cap 2 and a healing cap 3, includes the following steps:
Step 1: Use a dental implant 1 placed into an alveolar bone 13.
Step 2: Place the screw cap 2 onto the upper end of the dental implant 1.
Step 3: If the screw cap 2 only has the first protruding ring 21, suture the gum tissue 16 and cover the gum tissue 16 over the top of the screw cap 2 and the upper end of the dental implant 1. Then, in the space between the first protruding ring 21 of the screw cap 2 and the cap body 22 of the screw cap 2, accommodate proliferating gum tissue or bone.
Step 4: If the screw cap 2 has both the first protruding ring 21 and the second protruding ring 24, suture the gum tissue 16 and cover the gum tissue 16 over the top of the screw cap 2 and the upper end of the dental implant 1. Then, in the space between the first and second protruding rings 21 and 24 of the screw cap 2, accommodate proliferating gum tissue or bone, and in the space between the second protruding ring 24 and the threaded portion 23, accommodate proliferating gum tissue or bone.
Step 5: If the screw cap 2 only has the second protruding ring 24, suture the gum tissue 16 and cover the gum tissue 16 over the top of the screw cap 2 and the upper end of the dental implant 1. Then, in the space between the second protruding ring 24 and the threaded portion 23, accommodate proliferating gum tissue or bone.
Step 6: Cut the gum tissue 16 covering the top of the screw cap 2 and the upper end of the dental implant 1, and remove the screw cap 2.

As shown in FIGS. 2A to 2F, the method of placing a healing cap 3 of the improved prosthetic component of the present invention, includes the following steps:
Step 1: Use a dental implant 1 placed into an alveolar bone 13.
Step 2: Place the healing cap 3 onto the upper end of the dental implant 1.
Step 3: If the healing cap 3 only has the first protruding ring 311, suture the gum tissue 16 and cover the gum tissue 16 over the top of the healing cap 3 and the upper end of the dental implant 1, leaving only the top of the crown portion 31 exposed. Then, in the space between the first protruding ring 311 of the healing cap 3 and the threaded portion 34, accommodate proliferating gum tissue or bone.
Step 4: If the first protruding ring 311 of the healing cap 3 has a first recessed groove 301 between the crown portion 31, suture the gum tissue 16 and cover the gum tissue 16 over the top of the healing cap 3 and the upper end of the dental implant 1, leaving only the top of the crown portion 31 exposed. Then, the space of the first recessed groove 301 accommodates proliferating gum tissue or bone.
Step 5: If the second protruding ring 312 of the healing cap 3 has a second recessed groove 302 between the conical portion 42, suture the gum tissue 16 and cover the gum tissue 16 over the top of the healing cap 3 and the upper end of the dental implant 1, leaving only the top of the crown portion 31 exposed. Then, the space of the second recessed groove 302 accommodates proliferating gum tissue or bone.
Step 6: Cut the gum tissue 16 covering the top of the healing cap 3 and the upper end of the dental implant 1, and remove the healing cap 3.

As shown in FIGS. 3A to 3F, the method of placing an abutment tooth 4 of the improved prosthetic component of the present invention includes the following steps:
Step 1: Use a dental implant 1 placed into an alveolar bone 13.
Step 2: Place the abutment tooth 4 onto the upper end of the dental implant 1.
Step 3: If the abutment tooth 4 only has the first protruding ring 411, suture the gum tissue 16 and cover the gum tissue 16 over the top of the abutment tooth 4 and the upper end of the dental implant 1, leaving only the top of the support crown 41 exposed. Then, in the space between the first protruding ring 411 of the abutment tooth 4 and the conical portion 42, accommodate proliferating gum tissue or bone.
Step 4: If the abutment tooth 4 has both the first protruding ring 411 and the second protruding ring 421, suture the gum tissue 16 and cover the gum tissue 16 over the top of the abutment tooth 4 and the upper end of the dental implant 1, leaving only the top of the support crown 41 exposed. Then, in the space between the first protruding ring 411 and the second protruding ring 421, as well as the space between the first protruding ring 411 and the conical portion 42, accommodate proliferating gum tissue or bone.
Step 5: If the abutment tooth 4 only has the second protruding ring 421, suture the gum tissue 16 and cover the gum tissue 16 over the top of the abutment tooth 4 and the upper end of the dental implant 1, leaving only the top of the support crown 41 exposed. Then, in the space between the second protruding ring 421 and the cap body portion 43, accommodate proliferating gum tissue or bone.

The placement method involves using a nut (2) and a healing cap (3). The steps for placing the nut (2) and the healing cap (3) include:
Step 1: Use an implant body (1) placed in an alveolar bone (13).
Step 2: Use the nut (2) placed at the upper end of the implant body (1).
Step 3: Proceed to Step 3 from Step 2. If the nut (2) only has the first convex ring (21), first suture the gum tissue of the gingiva (16) and cover the gum tissue of the gingiva (16) over the upper end of the nut (2) and the upper end of the implant body (1). Then, in the space between the annular first convex ring (21) of the nut (2) and the body part (22) of the nut (2), accommodate the growth of at least one of the gum tissue or bone.
Step 4: Proceed to Step 4 from Step 2. If the nut (2) has both the annular first convex ring (21) and the annular second convex ring (24), first suture the gum tissue of the gingiva (16) and cover the gum tissue of the gingiva (16) over the upper end of the nut (2) and the upper end of the implant body (1). Then, in the space between the annular first convex ring (21) and the annular second convex ring (24) of the nut (2), accommodate the growth of at least one of the gum tissue or bone. Also, in the space between the annular second convex ring (24) and the threaded part (23) of the nut (2), accommodate the growth of at least one of the gum tissue or bone.
Step 5: Proceed to Step 5 from Step 2. If the nut (2) only has the second convex ring (24), first suture the gum tissue of the gingiva (16) and cover the gum tissue of the gingiva (16) over the upper end of the nut (2) and the upper end of the implant body (1). Then, in the space between the second convex ring (24) and the threaded part (23) of the nut (2), accommodate the growth of at least one of the gum tissue or bone.
Step 6: From Step 2 to Step 5, proceed to Step 6. Cut open the gum tissue of the gingiva (16) covering the upper end of the nut (2) and the upper end of the implant body (1), and remove the nut (2).
Step 7: Use the healing cap (3) placed on the upper end of the implant body (1).
Step 8: Proceed to Step 8 from Step 7. If the healing cap (3) only has the first convex ring (311), first suture the gum tissue of the gingiva (16) and cover the gum tissue of the gingiva (16) over the upper end of the healing cap (3) and the upper end of the implant body (1), leaving only the top end of the cap crown part (31) of the healing cap (3) exposed. Then, in the space between the first convex ring (311) and the threaded part (34) of the healing cap (3), accommodate the growth of at least one of the gum tissue or bone.
Step 9: Proceed to Step 9 from Step 7. If there is a first recessed groove (301) between the annular first convex ring (311) of the healing cap (3) and the cap crown part (31), first suture the gum tissue of the gingiva (16) and cover the gum tissue of the gingiva (16) over the upper end of the healing cap (3) and the upper end of the implant body (1), leaving only the top end of the cap crown part (31) of the healing cap (3) exposed. Then, the space of the first recessed groove (301) accommodates the growth of at least one of the gum tissue or bone.
Step 10: Proceed to Step 10 from Step 7. If there is a second recessed groove (302) between the annular second convex ring (312) of the healing cap (3) and the cap taper part (42), first suture the gum tissue of the gingiva (16) and cover the gum tissue of the gingiva (16) over the upper end of the healing cap (3) and the upper end of the implant body (1), leaving only the top end of the cap crown part (31) of the healing cap (3) exposed. Then, the space of the second recessed groove (302) accommodates the growth of at least one of the gum tissue or bone.
Step 11: From Step 7 to Step 11, proceed to Step 11. Cut open the gum tissue of the gingiva (16) covering the upper end of the healing cap (3) and the upper end of the implant body (1), and remove the healing cap (3).

As shown in FIGS. 1A to 1E and FIGS. 3A to 3F, the present invention provides a placement method for an improved prosthetic component, involving the use of a nut (2) and an abutment tooth (4). The steps for placing the nut (2) and the abutment tooth (4) include:
Step 1: Use an implant body (1) placed in an alveolar bone (13).
Step 2: Use the nut (2) placed at the upper end of the implant body (1).
Step 3: Proceed to Step 3 from Step 2. If the nut (2) only has the first convex ring (21), first suture the gum tissue of the gingiva (16) and cover the gum tissue of the gingiva (16) over the upper end of the nut (2) and the upper end of the implant body (1). Then, in the space between the annular first convex ring (21) of the nut (2) and the body part (22) of the nut (2), accommodate the growth of at least one of the gum tissue or bone.
Step 4: Proceed to Step 4 from Step 2. If the nut (2) has both the annular first convex ring (21) and the annular second convex ring (24), first suture the gum tissue of the gingiva (16) and cover the gum tissue of the gingiva (16) over the upper end of the nut (2) and the upper end of the implant body (1). Then, in the space between the annular first convex ring (21) and the annular second convex ring (24) of the nut (2), accommodate the growth of at least one of the gum tissue or bone. Also, in the space between the annular second convex ring (24) and the threaded part (23) of the nut (2), accommodate the growth of at least one of the gum tissue or bone.
Step 5: Proceed to Step 5 from Step 2. If the nut (2) only has the second convex ring (24), first suture the gum tissue of the gingiva (16) and cover the gum tissue of the gingiva (16) over the upper end of the nut (2) and the upper end of the implant body (1). Then, in the space between the second convex ring (24) and the threaded part (23) of the nut (2), accommodate the growth of at least one of the gum tissue or bone.
Step 6: From Steps 2 to 5, proceed to Step 6. Cut open the gum tissue of the gingiva (16) covering the upper end of the nut (2) and the upper end of the implant body (1), and remove the nut (2).
Step 7: Use the abutment tooth (4) placed on the upper end of the implant body (1).
Step 8: Proceed to Step 8 from Step 7. If the abutment tooth (4) only has the first convex ring (411), first suture the gum tissue of the gingiva (16) and cover the gum tissue of the gingiva (16) over the upper end of the abutment tooth (4) and the upper end of the implant body (1), leaving only the top end of the support crown (41) of the abutment tooth (4) exposed. Then, in the space between the first convex ring (411) and the taper part (42) of the abutment tooth (4), accommodate the growth of at least one of the gum tissue or bone.
Step 9: Proceed to Step 9 from Step 7. If the abutment tooth (4) has both the first convex ring (411) and the second convex ring (421), first suture the gum tissue of the gingiva (16) and cover the gum tissue of the gingiva (16) over the upper end of the abutment tooth (4) and the upper end of the implant body (1), leaving only the top end of the support crown (41) of the abutment tooth (4) exposed. Then, in the space between the annular first convex ring (411), the annular second convex ring (421), and the body part (43) of the abutment tooth (4), accommodate the growth of at least one of the gum tissue or bone. Also, in the space between the annular first convex ring (411) and the taper part (42) of the abutment tooth (4), accommodate the growth of at least one of the gum tissue or bone.
Step 10: Proceed to Step 10 from Step 7. If the abutment tooth (4) only has the second convex ring (421), first suture the gum tissue of the gingiva (16) and cover the gum tissue of the gingiva (16) over the upper end of the abutment tooth (4) and the upper end of the implant body (1), leaving only the top end of the support crown (41) of the abutment tooth (4) exposed. Then, in the space between the annular second convex ring (421) and the body part (43) of the abutment tooth (4), accommodate the growth of at least one of the gum tissue or bone.
Step 11: From Steps 7 to 10, proceed to Step 11. Use a dental prosthesis cap and place it on the upper end of the abutment tooth (4).

As shown in FIGS. 1A to 1E, FIGS. 2A to 2F, and FIGS. 3A to 3F, the present invention provides a method for placing an improved prosthetic component, using a screw cap 2 and an abutment tooth 4. The steps for placing the screw cap 2 and the abutment tooth 4 include:
Step 1: Use a dental implant 1 placed in an alveolar bone 13.
Step 2: Place the screw cap 2 on the upper end of the dental implant 1.
Step 3: If the screw cap 2 only has the first protruding ring 21, suture the gum tissue 16 and cover the gum tissue 16 over the top of the screw cap 2 and the upper end of the dental implant 1. Then, in the space between the first protruding ring 21 of the screw cap 2 and the cap body portion 22 of the screw cap 2, accommodate proliferating gum tissue or bone.
Step 4: If the screw cap 2 has both the first protruding ring 21 and the second protruding ring 24, suture the gum tissue 16 and cover the gum tissue 16 over the top of the screw cap 2 and the upper end of the dental implant 1. Then, in the space between the first protruding ring 21 and the second protruding ring 24 of the screw cap 2, accommodate proliferating gum tissue or bone, and in the space between the second protruding ring 24 and the threaded portion 23, accommodate proliferating gum tissue or bone.
Step 5: If the screw cap 2 only has the second protruding ring 24, suture the gum tissue 16 and cover the gum tissue 16 over the top of the screw cap 2 and the upper end of the dental implant 1. Then, in the space between the second protruding ring 24 and the threaded portion 23, accommodate proliferating gum tissue or bone.
Step 6: Cut the gum tissue 16 covering the top of the screw cap 2 and the upper end of the dental implant 1, and remove the screw cap 2.
Step 7: Place the abutment tooth 4 on the upper end of the dental implant 1.
Step 8: If the abutment tooth 4 only has the first protruding ring 411, suture the gum tissue 16 and cover the gum tissue 16 over the top of the abutment tooth 4 and the upper end of the dental implant 1, leaving only the top of the support crown 41 exposed. Then, in the space between the first protruding ring 411 and the conical portion 42, accommodate proliferating gum tissue or bone.
Step 9: If the abutment tooth 4 has both the first protruding ring 411 and the second protruding ring 421, suture the gum tissue 16 and cover the gum tissue 16 over the top of the abutment tooth 4 and the upper end of the dental implant 1, leaving only the top of the support crown 41 exposed. Then, in the space between the first protruding ring 411 and the second protruding ring 421, and the space between the first protruding ring 411 and the conical portion 42, accommodate proliferating gum tissue or bone.
Step 10: If the abutment tooth 4 only has the second protruding ring 421, suture the gum tissue 16 and cover the gum tissue 16 over the top of the abutment tooth 4 and the upper end of the dental implant 1, leaving only the top of the support crown 41 exposed. Then, in the space between the second protruding ring 421 and the cap body portion 43, accommodate proliferating gum tissue or bone.
Step 11: Cut the gum tissue 16 covering the top of the abutment tooth 4 and the upper end of the dental implant 1, and remove the abutment tooth 4.

The above descriptions and illustrations are for the preferred embodiment of the present invention. The skilled person in the art may make other modifications based on the patent scope defined above and the descriptions above, but these modifications should still be within the creative spirit and the scope of the claims of the present invention.

What is claimed is:

1. An improved prosthetic accessory, characterized by comprising:
a screw cap, where the upper end of the screw cap has a cap body portion, and the lower end of the screw cap has a threaded portion,
the cap body portion connects to the threaded portion, where the threaded portion locks into a dental implant, and the dental implant is located in an alveolar bone;
where the screw cap has a protruding ring structure, selected from at least one of a first protruding ring and a second protruding ring;
where the second protruding ring of the screw cap is located at the top extension of the cap body portion, and the first protruding ring is located at the upper extension of the second protruding ring of the screw cap;
where it only has the first protruding ring of the screw cap with an annular structure, and the space between the first protruding ring of the screw cap and the threaded portion is to accommodate proliferating gum tissue or bone, at least one of them;
where it has the annular structure of the first protruding ring and the second protruding ring of the screw cap, and the space between the first protruding ring and the second protruding ring and the cap body portion is to accommodate proliferating gum tissue or bone, at least one of them;
where it only has the second protruding ring of the screw cap, and the structure of the space between the second protruding ring and the threaded portion is to accommodate proliferating gum tissue or bone, at least one of them;
where the gum tissue forms part of the gum, and the bone forms part of the alveolar bone.

2. An improved prosthetic accessory, characterized by comprising:
a healing cap compatible with the screw cap described in claim 1, wherein the upper end of the healing cap has a crown portion, the lower end of the crown portion extends to a conical portion, the lower end of the conical portion connects to a cap body portion, and the lower end of the cap body portion connects to a threaded portion, where the threaded portion locks into a dental implant, and the dental implant is located in an alveolar bone;
where the healing cap has a protruding ring structure, selected from at least one of a first protruding ring and a second protruding ring;
where the first protruding ring of the healing cap is located at the junction between the cap body portion and the conical portion, and the second protruding ring of the healing cap is located at the junction between the crown portion and the conical portion;
where it only has the first protruding ring of the healing cap with an annular structure, and the structure of the space between the first protruding ring and the threaded portion is to accommodate proliferating gum tissue or bone, at least one of them;
where it only has the second protruding ring of the healing cap with an annular structure, and the structure of the space between the second protruding ring and the threaded portion is to accommodate proliferating gum tissue or bone, at least one of them;
where it simultaneously has the first protruding ring and the second protruding ring of the healing cap, and the space between the first protruding ring and the second protruding ring accommodates proliferating gum tissue or bone, at least one of them;
where the space between the second protruding ring of the healing cap and the threaded portion accommodates proliferating gum tissue or bone, at least one of them;
where the gum tissue forms part of the gum, and the bone forms part of the alveolar bone.

3. An improved prosthetic accessory, characterized by comprising:
A healing cap compatible with the screw cap described in claim 1, wherein the upper end of the healing cap has a crown portion, the lower end of the crown portion extends to a conical portion, the lower end of the conical portion connects to a cap body portion, and the lower end of the cap body portion connects to a threaded portion, where the threaded portion locks into a dental implant, and the dental implant is located in an alveolar bone;
Where the healing cap has a protruding ring structure, selected from at least one of a first protruding ring and a second protruding ring;
Where the first protruding ring of the healing cap is located at the junction between the conical portion and the cap body portion, and the second protruding ring of the healing cap is located at the junction between the crown portion and the conical portion;
where the first protruding ring of the healing cap has an annular structure, and the space between the first protruding ring and the threaded portion is to accommodate proliferating gum tissue or bone, at least one of them;
where the second protruding ring of the healing cap has an annular structure, and the space between the second protruding ring and the threaded portion is to accommodate proliferating gum tissue or bone, at least one of them;
where the gum tissue forms part of the gum, and the bone forms part of the alveolar bone.

4. An improved prosthetic accessory, characterized by comprising:
an abutment tooth compatible with the screw cap described in claim 1, selected from at least one structure of either a one-piece structure or a two-piece combined structure;
where the one-piece structure of the abutment tooth includes:
the upper end of the abutment tooth has a supporting crown, the lower end of the supporting crown connects to a conical portion, the lower end of the conical portion connects to a cap body portion, the lower end of the cap body portion connects to a threaded portion, where the threaded portion locks into a dental implant, and the dental implant is located in an alveolar bone;
where the abutment tooth has a protruding ring structure, selected from at least one of a first protruding ring and a second protruding ring;
where the first protruding ring of the abutment tooth is located at the junction between the supporting crown and the conical portion, and the second protruding ring is located at the junction between the conical portion and the cap body portion;
where it only has the first protruding ring of the abutment tooth with an annular structure, and the space between the first protruding ring and the cap body portion is to accommodate proliferating gum tissue or bone, at least one of them;
where the space between the first protruding ring and the second protruding ring, and the space between the second protruding ring and the cap body portion, is to accommodate proliferating gum tissue or bone, at least one of them;
where the gum tissue forms part of the gum, and the bone forms part of the alveolar bone;
where the two-piece combined structure of the abutment tooth includes:
the upper end of the abutment tooth has a supporting crown, the lower end of the supporting crown connects to a conical portion, the lower end of the conical portion connects to a cap body portion, the abutment tooth has a movable screw, where the supporting crown, the conical portion, and the cap body portion of the abutment tooth have a common axis, which is a perforation, and the movable screw is located at the center cavity of the perforation of the supporting crown, conical portion, and cap body portion. one end of the movable screw is a threaded portion, and the movable screw locks the abutment tooth in the dental implant, where the dental implant is located in the alveolar bone;
where the abutment tooth has a protruding ring structure, selected from at least one of a first protruding ring and a second protruding ring;
where the first protruding ring of the abutment tooth is located at the junction between the supporting crown and the conical portion, and the second protruding ring is located at the junction between the conical portion and the cap body portion;
where it only has the first protruding ring of the abutment tooth with an annular structure, and the space between the first protruding ring and the cap body portion is to accommodate proliferating gum tissue or bone, at least one of them;
where the space between the first protruding ring and the second protruding ring, and the space between the second protruding ring and the cap body portion, is to accommodate proliferating gum tissue or bone, at least one of them;
where the gum tissue forms part of the gum, and the bone forms part of the alveolar bone.
